(19) United States
(12) Patent Application Publication
(10) Pub. No.: US 2014/0095323 A1
(43) Pub. Date: Apr. 3, 2014

(54) Method of Second Price Auction with Monopoly Reserve Price and Apparatus Conducting the Same

(71) Applicant: YAHOO INC., Sunnyvale, CA (US)

(72) Inventors: Sergei Vassilvitskii, New York, NY (US); Patrick R. Jordan, Mountain View, CA (US); Uri Nadav, Menlo Park, CA (US); Mohammad Mahdian, Santa Clara, CA (US); Inbal Talgam-Cohen, Stanford, CA (US); Hu Fu, Ithaca, NY (US)

(73) Assignee: Yahoo Inc., Sunnyvale, CA (US)

(21) Appl. No.: 13/629,968

(22) Filed: Sep. 28, 2012

(51) Int. Cl. G06Q 30/02

(52) U.S. Cl. 705/14.71

(57) ABSTRACT

The present application relates to systems and computer-implemented methods for conducting a second price auction associated with an opportunity to realize an online advertisement. In some implementations, advertisers may be informed with the opportunity to realize the online advertisement, and may be provided with information associated with a user that may view the opportunity to realize the online advertisement; an individual reserve price may then be determined for each advertiser, based on the advertiser's individual bidding preference and the information associated with the user; and then the auction may be conducted to determine a winning bidder among candidate advertisers whose bidding price is higher than the individual reserve price associated therewith, using second price method.

### BACKGROUND

Online advertising is a form of promotion that uses the Internet and the World Wide Web to deliver marketing messages to attract customers. Examples of online advertising include contextual ads on search engine results pages, banner ads, blogs, Rich Media Ads, Social network advertising, interstitial ads, online classified advertising, advertising networks, and e-mail marketing. Right Media Exchange (RMX) is a marketplace of online advertising that enables advertisers, publishers, and ad networks to trade digital media through an application programming interface. Through a form of online advertisement auction, RMX provides publishers, i.e., media sellers, the visibility and control that provides the ability to maximize yield while driving engagement and return on advertisement spending for media buyers.

One of the key problems publishers or ad providers face within the RMX online advertisement auction today is how to set reserve (floor) prices, which is a minimum price the publisher wishes a winning bidder to pay, on their inventory. The problem becomes particularly acute as more of the online advertisement auctions move from a first-price rule, where the winning advertiser pays its bid, to a second-price rule, where the winning advertiser pays the minimum amount required to outbid the second-highest competitor.

Auction theory provides a compelling framework for how to set reserve prices based on bidder valuations. Particularly, in the context of online advertisement auctions for RMX, the bid of an advertisement on a particular page may vary significantly according to which user is viewing the ad. The current approach to facilitate bidders in evaluating an ad auction is to reveal the viewer information to the advertiser. For example, the viewer's gender, location, and websites the viewer has visited, etc. However, how much information of users is needed to incorporate into ad auctions poses an economic challenge to publishers or ad providers. For one thing, concealing information may only decrease social efficiency and attracts fewer bidders. On the other hand, while revealing information of the viewer may increase incentives of interested advertiser to bid, releasing too much information about the viewer may cause some potential bidders to be disinterested and turn them away, resulting in decreased competition and lower revenues.

As an example, suppose a first advertiser values presenting advertisements to males at $2 and presenting advertisements to females at $8. In an incentive compatible auction, the first advertiser may specifically bid $2 or $8 when a gender of a viewer is known, but when the gender of the viewer is not known (assuming an equal possibility of displaying an advertisement to a gender), the first advertiser may hedge and bid an expected value of $5. Similarly, a second advertiser may value presenting advertisements to males at $8 and presenting advertisements to females at $2 when the gender of the viewer is known, and the second advertiser may bid an expected value of $5 when the gender of the viewer is not known.

If it is revealed to the first and second advertisers that the gender of a viewer is female before the first and second advertisers bid on the opportunity to present their advertisement to the viewer, the publisher will receive a bid of $8 from the first advertiser and a bid of $2 from the second advertiser. When implementing a second price auction, the publisher collects $2. However, when the gender of the viewer is withheld before the first and second advertisers bid on the opportunity to present their advertisement to the bidder, the publisher will receive a bid of $5 from the first advertiser and a bid of $5 from the second advertiser. When implementing a second price auction, the publisher collects $5.

The example above may seem to suggest that revealing information can only decrease the expected revenue from a second price auction with two bidders. However, with a proper reserve price, a publisher may be able to counter the potential loss in competition and preserve the revenue.

### BRIEF DESCRIPTION OF THE DRAWINGS

The described systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a schematic diagram illustrating an example embodiment of a network environment;

FIG. 2 is a schematic diagram illustrating an example embodiment of a client device;

FIG. 3 is a schematic diagram illustrating an example embodiment of a server;

FIG. 4 illustrates one procedure of an online advertisement auction;

FIG. 5 illustrates one implementation of an auction scheme using a second-price rule with individual reserve price;

FIG. 6 illustrates an ironed Revenue Curve R(q) as a function of the quantile q.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments.

Example embodiments of the present application relate to computer-implemented methods and systems for conducting a second price online advertisement auction with monopoly reserve price. For better understanding of the present application, network environments and online advertising that the above methods and systems for conducting the second price online advertisement auction that may be operated in are first introduced as follow.

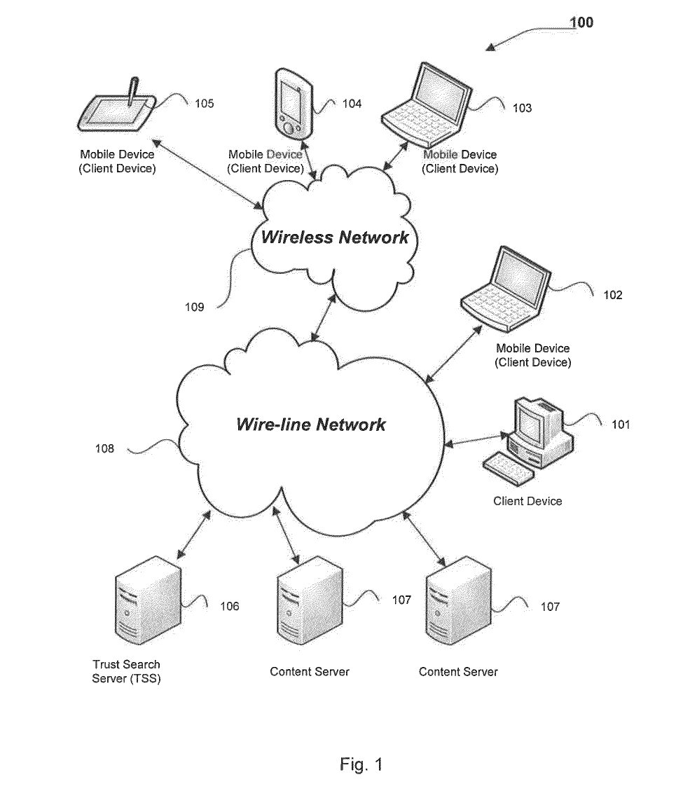

FIG. 1 is a schematic diagram of one embodiment illustrating a network environment that the methods in the present application may operate in. Other embodiments of the network environments that may vary, for example, in terms of arrangement or in terms of type or components, are also intended to be included within claimed subject matter. As shown, FIG. 1, for example, a network 100 may include a variety of networks, such as Internet, one or more local area networks (LANs) and/or wide area networks (WANs), wire-line type connections 108, wireless type connections 109, or any combination thereof. The network 100 may couple devices so that communications may be exchanged, such as between servers (e.g., content server 107 and search server 106) and client devices (e.g., client device 101-105 and mobile device 102-105) or other types of devices, including between wireless devices coupled via a wireless network, for example. A network 100 may also include mass storage, such as network attached storage (NAS), a storage area network (SAN), or other forms of computer or machine readable media, for example.

A network may also include any form of implementations that connect individuals via communications network or via a variety of sub-networks to transmit/share information. For example, the network may include content distribution systems, such as peer-to-peer network, or social network. A peer-to-peer network may employ computing power or bandwidth of network participants for coupling nodes via an ad hoc arrangement or configuration, wherein the nodes serves as both a client device and a server. A social network may be a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link. Overall, any type of network, traditional or modern, that may facilitate information transmitting or advertising is intended to be included in the concept of network in the present application.

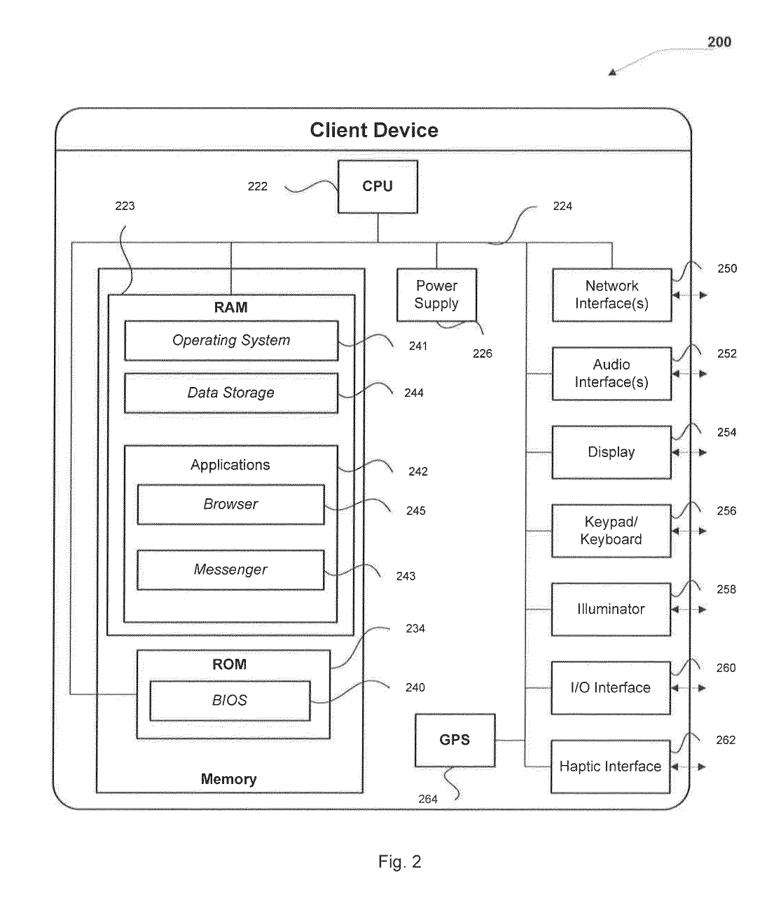

FIG. 2 is a schematic diagram illustrating an example embodiment of a client device. A client device may include a computing device capable of sending or receiving signals, such as via a wired or a wireless network. A client device may, for example, include a desktop computer 101 or a portable device 102-105, such as a cellular telephone or a smart phone 104, a display pager, a radio frequency (RF) device, an infrared (IR) device, a Personal Digital Assistant (PDA), a handheld computer, a tablet computer 105, a laptop computer 102-103, a set top box, a wearable computer, an integrated device combining various features, such as features of the forgoing devices, or the like.

A client device may vary in terms of capabilities or features. Claimed subject matter is intended to cover a wide range of potential variations. For example, a client device may include a keypad/keyboard 256 or a display 254, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 264 or other location-identifying type capability, or a display with a high degree of functionality, such as a touch-sensitive color 2D or 3D display, for example.

A client device may include or may execute a variety of operating systems 241, including a personal computer operating system, such as a Windows, iOS or Linux, or a mobile operating system, such as iOS, Android, or Windows Mobile, or the like. A client device may include or may execute a variety of possible applications 242, such as a browser 245 and/or a messenger 243. A client application 242 may enable communication with other devices, such as communicating one or more messages, such as via email, short message service (SMS), or multimedia message service MMS), including via a network, such as a social network, including, for example, Facebook™, LinkedIn™, Twitter™, Flickr™, or Google™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games such as fantasy sports leagues). The foregoing is provided to illustrate that claimed subject matter is intended to include a wide range of possible features or capabilities.

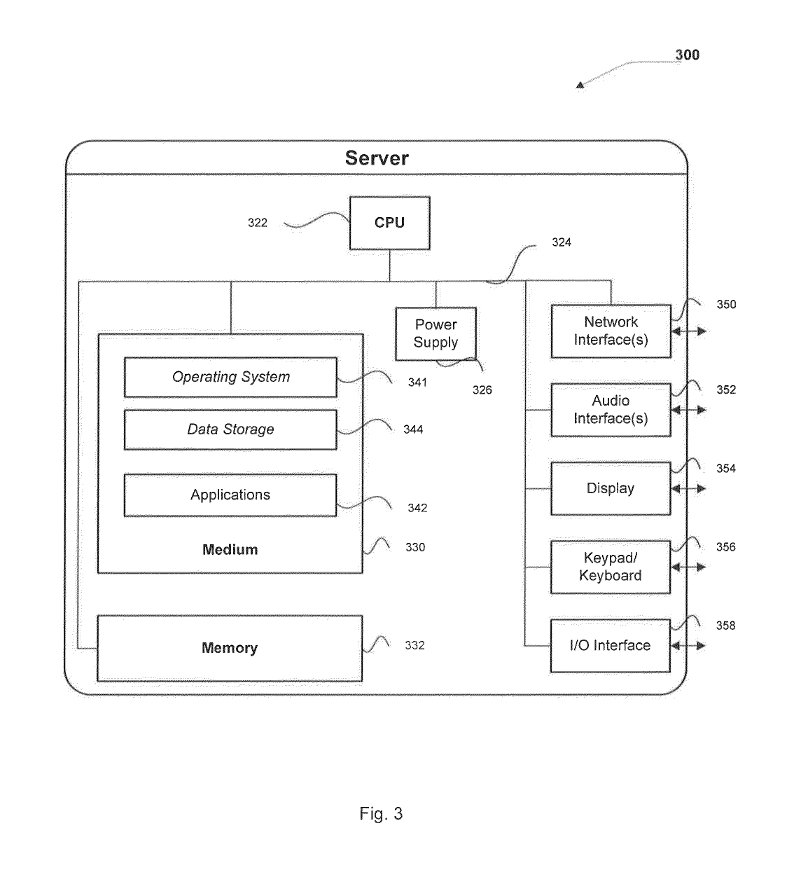

FIG. 3 is a schematic diagram illustrating an example embodiment of a server. A Server 300 may vary widely in configuration or capabilities, but it may include one or more central processing units 322 and memory 332, one or more medium 630 (such as one or more mass storage devices) storing application programs 342 or data 344, one or more power supplies 326, one or more wired or wireless network interfaces 350, one or more input/output interfaces 358, and/or one or more operating systems 341, such as Windows Server™, Mac OS X™, Unix™, Linux™, FreeBSD™, or the like. Thus a server 300 may include, as examples, dedicated rack-mounted servers, desktop computers, laptop computers, set top boxes, integrated devices combining various features, such as two or more features of the foregoing devices, or the like.

The server 300 may serve as a search server 106 or a content server 107. A content server 107 may include a device that includes a configuration to provide content via a network to another device. A content server may, for example, host a site, such as a social networking site, examples of which may include, but are not limited to, Flicker™, Twitter™, Facebook™, LinkedIn™, or a personal user site (such as a blog, vlog, online dating site, etc.). A content server 107 may also host a variety of other sites, including, but not limited to business sites, educational sites, dictionary sites, encyclopedia sites, wikis, financial sites, government sites, etc. A content server 107 may further provide a variety of services that include, but are not limited to, web services, third party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor type or programmable consumer electronics, etc.

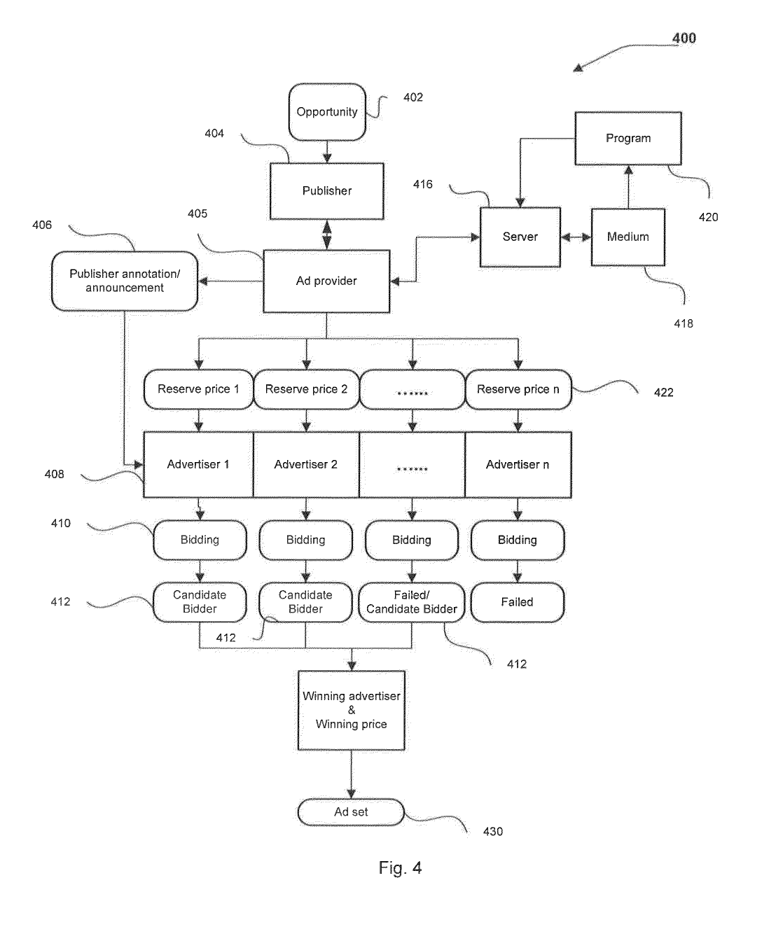

FIG. 4 is a block diagram of one example embodiment illustrating one implementation of a procedure of an online advertisement auction. However, it should be appreciated that the systems and methods described below are not limited to use with an auction for online advertisement display. In the context of RMX, a webpage of a publisher 404 may be viewed by various viewers and/or internet users for a number of times in a particular time period. Every time when a webpage of a publisher 404 is viewed, an online advertising opportunity 402 is created. The publisher 404 may monetize the opportunity 402 by providing the opportunity 402 for advertisers 408, who are targeting their advertisements to specific viewers, to realize an online advertisement on that webpage through ad network/exchanges.

Here, “ad exchanges” may be an organization system that associates advertisers or publishers, such as via a platform to facilitate buying or selling of online advertisement inventory from multiple ad networks; and “ad networks” may refer to aggregation of ad space supply from publishers, such as for provision en masse to advertisers. The advertiser may be any interested parties and the realization may be of any form. For convenience purposes, the present application uses display of an advertisement impression as an example of advertisement realization, but it should be noted that the description intends to include all forms of realization associated with online advertisements. For example, realization of an online advertisement may include an impression of an online advertisement, a click-through associated with an online advertisement, an action associated with an online advertisement, an acquisition associated with an online advertisement, a conversion associated with an online advertisement, or any other type of realization associated with an online advertisement that is known in the art.

For web portals like Yahoo!™, advertisements may be displayed on web pages resulting, from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements may include employing demographic characteristics (e.g., age, income, sex, occupation, etc.) for predicting user behavior, such as by group. Advertisements may be presented to users in a targeted audience based at least in part upon predicted user behavior(s). Another approach may include profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

To realize an online advertisement on the webpage of the publisher 404 through ad network/exchanges, the publisher 404 may set up the opportunity 402 with an ad provider 405 (such as Yahoo!™ Marketing). To this end, the advertisers 408 may register with the ad provider 405 and set up accounts and advertisements including information such as their bidding permutations with the ad provider 405. The ad provider 405 may then receive an ad request from the publisher 404 and conduct an auction based on the information saved from the advertisers 408. Then the ad provider 405 may send a selected advertisement to the publisher 408 for realization (e.g., display to an Internet user).

Thus, for each online advertisement to be realized, the publisher 404 or the ad provider 405 may reveal to advertisers 408 relevant information/features of online advertising opportunity 402. The relevant information/features may include, but may not be limited to, an advertisement key word, website visiting information, information related to where the advertisement is about to be rendered (such as the section of a webpage, a Uniform Resource Locater (URL) of the webpage, a location on the webpage, and/or a size of the advertisement on the webpage). The relevant information/features may also include information associated with the viewers, such as their demographic information (e.g., age, income, sex, occupation, geographic information, search history, and/or information stored in cookies of their computer and/or internet surfing devices, etc.). Further, the information of the viewer may be revealed to each advertiser based on individual preference of the advertiser (e.g., historical bidding preference of the advertiser and/or the field of advertisements that the advertiser is specialized in) towards the viewer, thus the information revealed may vary among advertisers 408.

Once the advertisers 408 received an annotation 406 of the online advertisement realization opportunity 402 from the ad provider 405, the ad provider 405 may seek monetize the online advertisement realization opportunity 402 by holding an online advertisement auction among the advertisers 408.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as pay-per-impression, pay-per-click, pay-per-acquisition, or any other online advertisement auction methodology known in the art. Advertiser payment for online advertising may be divided between parties including one or more publishers or publisher networks, one or more marketplace facilitators or providers, or potentially among other parties. Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

The online advertisement auction may adopt a second-price rule, and each advertiser 408 who is participating in the auction may receive an individual reserve price 422 (i.e., a monopoly reserve price) specifically set by the ad provider 405 or the publisher 404. The individual reserve price is determined based on the individual bidding behavior and/or preference of the advertiser and the information of the viewer being disclosed to the advertisers. For example, by observing the historical bidding behavior and/or preference of two particular advertisers, Advertiser 1 and Advertiser 2, the ad provider 405 or the publisher 404 may obtain knowledge that Advertiser 1 mainly focuses on advertising high end business wear for females between 35-year old and 45-year old and Advertiser 2 mainly advertise sport facilities for male consumers between 18-year old and 28-year old. Thus if the viewer of the opportunity is a 20-year old male college student who regularly purchases tennis balls online and is an active member in an online tennis forum, Advertiser 2 may find the opportunity 402 to realize an advertisement to the potential viewer to be more valuable than Advertiser 1 finds the opportunity to display an online advertisement to the potential viewer. Conversely, if the ad provider 405 discloses to the advertisers 408 that the viewer of the present opportunity 402 is a 40-year old female working for a large investment bank as a senior manager, Advertiser 1 may find the opportunity 402 to display an online advertisement to the potential viewer to be more valuable than Advertiser 2 finds the opportunity to realize an online advertisement to the potential viewer. Thus, when the ad provider 405 discloses to the advertisers 408 the coming opportunity to display an online advertisement for viewing by the female manager, the ad provider 405 may expect that Advertiser 1 may bid a price higher than Advertiser 2. Accordingly, the ad provider 405 may set a higher individual reserve price, Reserve Price 1, for the Advertiser 1 and set a lower individual reserve price, Reserve Price 2, for Advertiser 2.

To determine the individual reserve prices for the advertisers 408, the ad provider 405 may send the information of the opportunity 402 and information of each advertiser (i.e., Advertiser 1, Advertiser 2 . . . , and Advertiser n) to a server 416, which may be a personal computer, a workstation, or a terminal in a network. The server 416 may search a database of historical online advertisement auctions stored in a medium 418, such as a computer-readable storage medium or any other suitable storage medium, through set of instructions stored in the medium 418. The medium 418 may connect directly to the server or connect indirectly to the server, through physical connection or through wireless communications. The database may include data of historical online advertisement auctions of opportunities similar to the current opportunity 402. The database may also include historical online advertisement auctions and analyses that reflect bidding behavior and preferences of each advertiser 408.

The server 416 may analyze the information of the opportunity 402 and information of each advertiser 408 and return to the ad provider 405 a suggested individual reserve price for every advertiser 408. The ad provider 405 may then use the suggested reserve prices as reference values for the individual reserve prices 422 (i.e., Reserve Price 1, Reserve Price 2 . . . , Reserve Price n) and conduct the online advertisement auction.

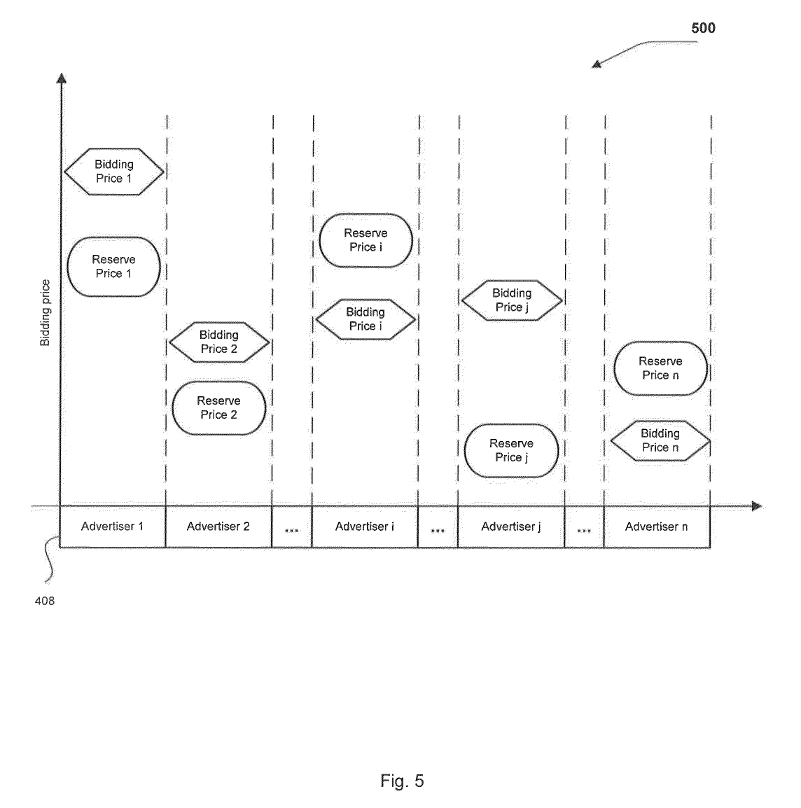

FIG. 5 is a schematic illustration of one implementation of an online advertisement auction scheme that the ad provider 405 may conduct using the second-price rule with individual reserve prices. First, the ad provider 405 may identify candidate bidders 412 from the advertisers 408 that participate in the online advertisement auction. When the online advertisement auction starts, each advertiser (i.e., Advertiser 1, Advertiser 2 . . . , Advertiser i . . . , Advertiser j . . . , and Advertiser n) may individually bid the opportunity 402 to display their advertisement. If an advertiser 408 bids a price that is lower than its individual reserve price, the bid of the advertiser fails. However, if an advertiser 408 bids a price that is higher than its individual reserve price, the advertiser 408 may be promoted to be a candidate bidder 412 and become qualified to participate the next stage of the auction. For example, as illustrated in FIG. 5, the highest prices (i.e., Bidding Price i and Bidding Price n) that Advertiser i and Advertiser n bid are lower than their individual reserve prices (i.e., Reserve Price i and Reserve Price n). Thus, the bids of Advertiser i and Advertiser n fail and Advertiser i and Advertiser n do not become candidate bidders. The prices (i.e., Bidding Price 1, Bidding Price 2, and Bidding Price j) that Advertiser 1, Advertiser 2 and Advertiser j bid are higher than their respective individual reserve price (i.e., Reserve Price 1, Reserve Price 2, and Reserve Price n). Accordingly, Advertiser 1, Advertiser 2 and Advertiser j are promoted to be candidate bidders 412.

Thus, a list of candidate bidders 412 and their respective bidding prices may be identified after all advertisers 408 complete their bidding against their respective individual reserve prices. Next, the ad provider 405 may identify a winning bidder among the candidate bidders 412 and determine a winning price for the winning bidder. The candidate bidder 412 who bids the highest bidding price may be selected as the winning bidder and win the opportunity 402.

The winning price that the winning bidder pays may be either the second highest price bids by the candidate bidders 412 or the individual reserve price of the winner bidder, whichever is higher, i.e., the winning price may be a second highest price among the bidding prices of the candidate bidders 412 when the second highest price is greater than or equal to the individual reserve price of the winning bidder; and the winning price may be the individual reserve price of the winning bidder when the second highest price is less than the individual reserve price of the winning bidder. For example, in FIG. 5, Advertiser 1 is the candidate bidder who bids the highest bidding price (i.e., Bidding Price 1). The second highest bidding price among the candidate bidders is Bidding Price j. Thus the winning price that Advertiser 1 pays for the opportunity 402 may be either Bidding Price j or Reserve Price 1, whichever is higher. Since in FIG. 5 the Reserve Price 1 is higher than the Bidding Price j, the winning price that Advertiser 1 pays may be the Reserve Price 1.

After conducting the online advertisement auction, the ad provider 405 may return the auction results to the publisher 404, such as the identity of the winning bidder, and the advertisement to be realized, and revenue from the auction.

Thus, by implementing individual reserve price, the methods and systems disclosed in the present application provide the ability to counter decreased bidding competition caused by revealing viewer information of an opportunity that is associated with online advertisement.

The following is a more detailed analytical description of the above-stated auction method.

1. Preliminaries

As the outset of the description, the following is a preliminary of Myerson's optimal mechanism. According to Myerson's optimal mechanism, in a single-item, truthful auction where bidders' valuations are drawn independently from known distributions D₁, . . . , Dₙ, the expected revenue (a.k.a. virtual surplus) collected by assigning the item to bidder i with valuation vᵢ maybe expressed as:

$${ϕ}_{i} ( {v}_{i} ) = {v}_{i} - \frac{1 - {F}_{i} ( {v}_{i} )}{{f}_{i} ( {v}_{i} )} ,$$

where Fᵢ is the cumulative distribution function of Dᵢ, and fᵢ is a density function of Dᵢ. φᵢ(vᵢ) is called the virtual valuation of vᵢ. When φᵢ(vᵢ) is a monotone non-decreasing function of vᵢ, the corresponding distribution is said to be regular. In a special case when

$$\frac{1 - {F}_{i} ( {v}_{i} )}{{f}_{i} ( {v}_{i} )}$$

is a monotone non-increasing function of vᵢ it is said to have monotone hazard rate (MHR). When all distributions are regular, an optimal truthful mechanism may be simply to assign the item to a bidder with the highest nonnegative virtual valuation. When the distributions are not regular, however, such an allocation may not be truthful. For such cases, a procedure called ironing may be used to monotonize virtual valuations and produces so-called ironed virtual valuations { φ̅ᵢ(vᵢ)}, wherein φ̅ᵢ(vᵢ) is monotone non-decreasing with respect to vᵢ for all distributions, and the optimal truthful auction may allocate the item to the bidder with the highest nonnegative ironed virtual valuation. The optimal expected revenue, therefore, may be expressed as

[symbol]

[max{0, φ̅(v₁), . . . , φ̅ᵢ(vᵢ)}].

The (ironed) virtual value may be seen as marginal revenue, which is the derivative of (ironed) revenue curve. Given a distribution, each probability quantile q corresponds to a value F⁻¹(1−q). Each value, in turn, corresponds to an expected revenue v(1−F(v)) generated by setting a posted price of v. A revenue curve depicts such revenue R(q) as a function of the quantile q, as shown in FIG. 5, and the ironed revenue curve is the concave hull of this curve, as indicated by the dashed curve in FIG. 5. The ironed virtual valuation of v is then

$$\frac{d \tilde{R} ( q )}{d q} {\vert}_{q = 1 - F ( v )} .$$

2. Model

After setting out the basis of Myerson's optimal mechanism, a model for an advertisement auction is described as follows. The model assumes that there are n advertisers bidding on an opportunity to show an advertisement to the specific user, and there are m different types of users and that the distribution over user types is publicly known. Formally, every user may be characterized by a discrete random variable U drawn from a publicly known distribution F_{U} on support {1, . . . , m}. The publisher may have access to information about the type of user viewing the impression, i.e., she may know the realization u of U (u may be also called the auctioneer's signal). In contrast, unless the publisher decides to reveal u, the advertisers may only know the distribution F_{U}, and in this case it may be convenient to say that the advertisers know the user is of a fictitious average type ū.

To value the impression offered to them by the publisher, every advertiser may gain a private utility sᵢ from the event that the user clicks on his advertisement (sᵢ is also called advertiser i's signal). In a setting in which sᵢ is drawn independently at random from a publicly known distribution Fᵢ with density fᵢ, advertiser i's value vᵢ for the impression may be sᵢ times the probability of the user clicking on the advertisement, called the click through rate (CTR).

While the advertiser's value per click, sᵢ, may or may not depend on the type of user who clicks on the advertisement, the CTR may be completely determined by the user's type. For every u ∈ {1, . . . , m} ∪ {ū}, we denote by p_{i,u} the probability that a user of type u clicks on advertiser i's advertisement. By definition,

p_{i,ū}= [symbol] _{u˜F}_{_{U}}[p_{i,u}].

wherein [symbol] _{u˜F}_{_{U}} representing the revenue expectation when u is an random variable from distribution F_{U}. Assuming that the publisher knows the value of p_{i,u} for every i, u, advertiser i's value for the impression may be expressed as

vᵢ=p_{i,u}sᵢ.

In a direct revelation mechanisms where the advertisers directly report their private signals, taking into account of incentive compatibility and individual rationality (IR), the online advertisement auctions in the model may have the following form:
(1) The auctioneer commits to whether or not she will use its knowledge of the user's type during the auction.
(2) The auctioneer learns the user's type.
(3) The advertisers report their values per click {sᵢ}.
(4) For every i, the auctioneer calculates the value per impression vᵢ=p_{i,u}sᵢ, where u is either the user's known type or ū if the type information is ignored.
(5) The auctioneer runs a truthful IR mechanism on {vᵢ}.

Note that if the advertisers know the CTRs {p_{i,u}}, the above may be equivalent to first letting the publisher decide whether or not she will reveal the user's type to the advertisers, and then (after realization and possible revelation of the type) having the advertisers calculate and bid their values vᵢ and running a truthful IR mechanism. The above mechanism thus may be truthful and IR in expectation. In what follows, we say that the publisher reveals the user type, if she uses it in the auction to calculate the values {vᵢ}.

It should be noted that this model assumes that the publisher uses the true type of the user, and do not address here the interesting but separate question of incentivizing the auctioneer to be honest (e.g., by designing appropriate reputation mechanisms, etc.). The model also assumes that the publisher has exclusive knowledge of the user's identity. Thus it may be on the publisher discretion to reveal the user's identity, or the publisher may opt not to reveal the user's identity to the advertisers until after the auction has taken place (note that this is a separate decision from whether or not to use the user's type in the auction).

3. Revenue Monotonicity of the Optimal Mechanism

Next, we show that when Myerson's optimal mechanism is applied to the above-described model, the expected revenue may weakly increases when the auctioneer fully reveals its information regarding the user's type.

Recall that applying Myerson's mechanism to the setting set forth above may mean that the publisher calculates the ironed virtual valuation φ̅ᵢ(vᵢ) for each advertiser given his bid {vᵢ} and then allocates the item to the bidder with the highest non-negative ironed virtual valuation.

Thus an observation (Observation 1) may be described as follows: Observation 1: let u ∈ {1, . . . , m} ∪ {ū}, vᵢ=p_{i,u}sᵢ. The distribution of vᵢ may be:

$${F}_{i , u} ( x ) = {F}_{i} ( \frac{x}{{p}_{i , u}} )$$

and the corresponding ironed virtual value function may be:

$${\overline{ϕ}}_{i , u} ( x ) = {p}_{i , u} {\overline{ϕ}}_{i} ( \frac{x}{{p}_{i , u}} ) .$$

The last equality follows by looking at the revenue curves:

$$\begin{matrix}{R}_{i , u} ( 1 - {F}_{i , u} ( x ) ) = x ( 1 - {F}_{i , u} ( x ) ) \\ = {p}_{i , u} \cdot \frac{x}{{p}_{i , u}} ( 1 - {F}_{i} ( \frac{x}{{p}_{i , u}} ) ) \\ = {p}_{i , u} {R}_{i} ( 1 - {F}_{i} ( \frac{x}{{p}_{i , u}} ) ) .\end{matrix}$$

The ironed revenue curves are concave hulls of the revenue curves, and therefore may preserve this relationship:

$${\tilde{R}}_{i , u} ( 1 - {F}_{i , u} ( x ) ) = {p}_{i , u} {\tilde{R}}_{i} ( 1 - {F}_{i} ( \frac{x}{{p}_{i , u}} ) ) .$$

The ironed virtual valuations, which are their derivatives, therefore satisfy the same linear relationship.

The next observation (Observation 2) may be useful in analyzing the expected revenue from Myerson's mechanism with and without revealing information about the user type. By Observation 1 and the definition of p_{i,u}, for every value per click sᵢ, the ironed virtual value for the impression when the user's type is not used is the expected ironed virtual value when the type is used. Observation 2 may be expressed as follows:

$$\begin{matrix}{\overline{ϕ}}_{i , \overline{u}} ( {p}_{i , \overline{u}} {s}_{i} ) = {p}_{i , \overline{u}} {\overline{ϕ}}_{i} ( {s}_{i} ) \\ = {E}_{i - {F}_{U} [ {p}_{i , u} ] {\overline{ϕ}}_{i} ( {s}_{i} )} \\ = {E}_{u - {F}_{U}} [ {p}_{i , u} {\overline{ϕ}}_{i} ( {s}_{i} ) ] \\ = {E}_{u - {F}_{U}} [ {\overline{ϕ}}_{i , u} ( {p}_{i , u} {s}_{i} ) ]\end{matrix}$$

We now state our main result.

Proposition 1 (Revenue Monotonicity): The expected revenue from Myerson's mechanism when the user's type is revealed may be at least as high as the expected revenue when the user's type is not revealed.

Proof: Myerson proved that the expected revenue of any truthful mechanism is equal to its expected ironed virtual surplus. We use Myerson's result to prove Proposition 1 pointwise, i.e., we show that it holds for every fixed profile of values per click (s₁, . . . , sₙ). Taking expectation over the profiles completes the proof.

Fix (s₁, . . . , sₙ) and let u ∈ {1, . . . , m} be the user's known type. The virtual surplus of Myerson's mechanism when u is revealed is

max{0, φ̅_{1,u}(p_{1,u}s₁), . . . , φ̅ₙᵤ(_{pn,u sn})}

Taking expectation over u gives the expected virtual surplus when the users type is revealed

E_{u˜F}_{_{U}}[max{0, φ̅_{1,u}(p_{1,u}s₁), . . . , φ̅_{n,u}(p_{n,u}sₙ)}]

If u is not revealed, the virtual surplus of Myerson's mechanism is

max{0, φ̅_{1,u}(p_{1,ū}s₁), . . . , φ̅_{n,u}(p_{n,u}sₙ)}

By Observation 2, this is equal to

max{0} ∪ {E_{u˜F}_{_{U}}[ φ̅_{i,u}(p_{i,u}sᵢ)]}ᵤ₌₁ⁿ. (2)

Since max is a convex function, by Jensen's inequality equation (1)≧equation (2), so revealing the user's type does not reduce the expected revenue.

4. Strategic Revelation

Up until now we've considered only two possibilities for the auctioneer—to fully reveal the user's type or to conceal it. However, there may be also many intermediate possibilities. Let r: {1, . . . , m}→2^{{1, . . . , m}} be a revelation strategy, which takes the real user type u ∈ {1, . . . , m} and outputs a (possibly random) subset of user types r(u) (r(u) may also be defined more generally to include reports beyond subsets of types, such as summary statistics etc.). Possible strategies include r(u)=u (full revelation), r(u)={1, . . . , m} (no revelation), r(u) [symbol] u (partial revelation), and noisy revelation in which r(u) may not even contain the real type u.

The online advertisement auction now proceeds as follows. The publisher may publicly commit (before learning the user's type u) to a revelation strategy r. This strategy, together with the realized subset r(u) and the type distribution F_{U}, may induce a new ex post distribution \check{F}_{U} on the user types. In order to maintain incentive compatibility, the auctioneer sets vᵢ according to this distribution as E_{u˜ F̅}_{_{U}}[p_{i,u}Sᵢ] (equivalently, the auctioneer reveals r(u) to the advertisers and they report their values {vᵢ} where vᵢ=E_{u˜ F̅}_{_{U}}[p_{i,u}sᵢ]).

A direct corollary of Proposition 1 is that the full revelation strategy yields the highest expected revenue of all revelation strategies. This corollary may be expressed as:

Corollary 1 (Full Revelation is Optimal): For every revelation strategy r, the expected revenue from Myerson's mechanism is upper bounded by the expected revenue when the user's type is fully revealed.

The proof of Corollary 1 is set forth as follows: Condition on the revealed subset r(u). Together with r and F_{U} it induces the distribution F̅_{U} on the user types. We may now apply Proposition 1 to conclude that the expected revenue from full revelation of u is at least as high as the expected revenue from revealing r(u).

5. Simple Auctions with Reserve Prices

In this section, we present examples of simple auctions with reserve prices. We look at two types of such auctions: the second price auction with an anonymous reserve price, and the second price auction with monopoly reserve prices. In the former, a single reserve price is applied to all bidders, and those who bid above the reserve price compete in the second price auction. In the latter, an individual reserve price, or a monopoly reserve price, is applied to each advertiser, and advertisers who bid above their respective reserve prices enter the second price auction. A monopoly reserve price (individual reserve price) for an advertiser may be the optimal reserve price set in an auction with this bidder alone. Equivalently, it is equal to the value v whose corresponding ironed virtual value φ̅(v) is 0.

Our examples show that releasing data can decrease the expected revenue even when the values are drawn from MHR distribution (a special case of regular distribution). However, for all regular distributions, the simple auctions we consider are guaranteed to give at least a constant factor of the optimal expected revenue. We use this fact to show that since releasing data does not hurt the optimal expected revenue, the loss in expected revenue from data revelation in simple auctions may be bounded by a constant factor.

5.1 Second Price Auctions with Anonymous Reserve

This section gives an example in which announcing the item type decreases the revenue of the second price auction with the optimal anonymous reserve price.

In this example, suppose n=2, i.e., there are two advertisers, and m=2, i.e., there are two type of users, with F_{U} being uniform between 1 and 2. Advertiser 2 is not sensitive to the type of the item, whereas p_{1,1}=2 and p_{1,2}=0. We will call user type 1 a “high” type, and user type 2 a “low” type. The two advertisers' valuations for ū are drawn independently and uniformly from [0, 1].

When the type is not announced, the optimal auction is a second price auction with reserve price ½, and the optimal revenue is 5/12. When the item is a low type, the optimal auction is a second price auction with a reserve price ½, and the revenue is ¼. We now compute the optimal anonymous reserve price for a high type and the revenue it generates. When setting a reserve price to be x ∈ [0, 1], the revenue is

$$x [ x ( 1 - \frac{x}{2} ) + \frac{x}{2} ( 1 - x ) ] + {\int }_{x}^{1} y ( 1 - \frac{y}{2} ) + \frac{y}{2} ( 1 - y ) d y = \frac{3}{4} {x}^{2} - \frac{2}{3} {x}^{3} + \frac{5}{12} .$$

To maximize this, we set x to be ¾, and the revenue is 9/64+ 5/12. Setting a reserve price in [1, 2] does no better (the optimal reserve price in that interval is 1, which generates a revenue of 0.5).

Therefore, for a high type, the revenue of an optimal second price auction with an anonymous reserve price is 9/64 more than 5/12, whereas for a low type the revenue is ⅙ less. On average, if we reveal the type, the expected revenue is strictly less than 5/12.

5.2 Second Price Auction with Monopoly Reserves

This section presents an example in which announcing the item type decreases the revenue of the second price auction with monopoly reserve prices.

As in the previous section, the example is on two advertisers and m is set to 2, with F_{U} being uniform between 1 and 2. Advertiser 2 may be insensitive to the type of the item, while p_{1,1}=4/3 and p_{1,2}=⅔. Again, type 1 is called a high type, and type 2 is called a low type. Both advertisers' valuations for ū are uniformly drawn from [0, 6].

When the type is not announced, the optimal auction is a second price auction with reserve price 3, and the expected revenue is 2.5.

When the item is of high type, the monopoly reserves are 4 and 3, respectively. The expected revenue is:

$$4 \cdot Pr ( {v}_{1} ∈ [ 4 , 8 ] , {v}_{2} ∈ [ 0 , 3 ] ) + 3 \cdot Pr ( {v}_{1} ∈ [ 0 , 4 ] , {v}_{2} ∈ [ 3 , 6 ] ) + 4 \cdot Pr ( {v}_{1} ∈ [ 4 , 8 ] , {v}_{2} ∈ [ 3 , 4 ] ) + \frac{14}{3} \cdot Pr ( {v}_{1} , {v}_{2} ∈ [ 4 , 6 ] ) + 5 \cdot Pr ( {v}_{1} ∈ [ 6 , 8 ] , {v}_{2} ∈ [ 4 , 6 ] ) = 2.889$$

When the item is of low type, the monopoly reserves are 2 and 3, respectively. The expected revenue is:

$$2 \cdot Pr ( {v}_{1} ∈ [ 2 , 4 ] , {v}_{2} ∈ [ 0 , 3 ] ) + 3 \cdot Pr ( {v}_{1} ∈ [ 0 , 2 ] , {v}_{2} ∈ [ 3 , 6 ] ) + 3 \cdot Pr ( {v}_{1} ∈ [ 2 , 3 ] , {v}_{2} ∈ [ 3 , 6 ] ) + \frac{7}{2} \cdot Pr ( {v}_{1} ∈ [ 3 , 4 ] , {v}_{2} ∈ [ 4 , 6 ] ) + \frac{10}{3} \cdot Pr ( {v}_{1} , {v}_{2} ∈ [ 3 , 4 ] ) = 2.0556$$

Thus when the type is announced, the expected revenue is 2.4722, which is less than 2.5.

5.3 Upper Bound on Revenue Loss

Theorem 5.1: For every single-item setting with values drawn independently from regular distributions:

(1) [10, Theorem 5.1] There is an anonymous reserve price such that the expected revenue of the second price auction with this reserve is a 4-approximation to the optimal expected revenue.

(2) [10, Theorem 3.7] The expected revenue of the second price auction with monopoly reserves (individual reserve price) is a 2-approximation to the optimal expected revenue.

Corollary 5.2: The expected revenue from the second price auction with anonymous reserve (resp., monopoly reserves) when the user's type is revealed is a 4-approximation (resp., 2-approximation) to the expected revenue when the user's type is not revealed.

Proof: By Theorem 5.1, the expected revenue from the second price auction with anonymous reserve (resp., monopoly reserves) when the user's type is revealed is a 4-approximation (resp., 2-approximation) to the optimal expected revenue when the user's type is revealed, which by Proposition 4.3 is as high as the optimal expected revenue when the type is not revealed.

As described above, systems and computer-implemented methods may provide advertiser of online advertising opportunity auctions individual reserve price, which publishers of the online auctions may use to counter the negative effect on bidding competition that is caused by disclosing certain information of viewers of the opportunities being auctioned. In addition, the present application also provides programs adopting that described methods, where the programs comprise instructions stored on a computer-readable storage medium that may be executed by a processor of a device such as servers.

However, it is intended that the foregoing detailed description be regarded as illustrative rather than limiting, and that it be understood that it is the following claims, including all equivalents, that are intended to define the spirit and scope of this invention.

For example, while the above-described systems and methods have been described with respect to individualizing the reserve prices of advertisement realization auctions, it will be appreciated that the same systems and methods may be implemented to individualize the reserve prices of auctions that are not related to advertisement realization.

Further, while the above-described systems and methods have been described with respect to individualizing the reserve prices of online auctions, it will be appreciated that the same systems and methods may be implemented to individualize the reserve prices of auctions that are not held online and/or not related to online activities.

Also, while the above-described systems and methods have been described with respect to individualizing the reserve prices of auctions held by publishers and bided by advertisers, it will be appreciated that the same systems and methods may be implemented to individualize the reserve prices of auctions held by any auction holder and bided by any auction attendances.

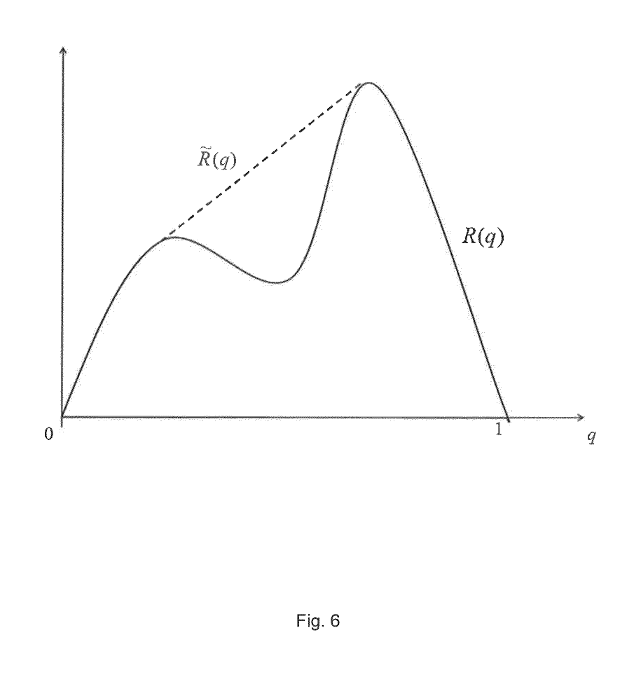

In addition, while example embodiments have been particularly shown and described with reference to FIGS. 1-6, it will be understood by one of ordinary skill in the art that various changes in form and details may be made therein without departing from the spirit and scope of example embodiments, as defined by the following claims. The example embodiments, therefore, are provided merely to be illustrative and subject matter that is covered or claimed is intended to be construed as not being limited to any example embodiments set forth herein. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in one example embodiment” as used herein does not necessarily refer to the same embodiment and the phrase “in another embodiment” or “in another example embodiment” as used herein does not necessarily refer to a different embodiment. It is intended, for example, that claimed subject matter include combinations of example embodiments in whole or in part.

The terminology used in the specification is for the purpose of describing particular embodiments only and is not intended to be limiting of example embodiments of the invention. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

We claim:

1. A computer-implemented method for implementing a second price auction associated with an opportunity to realize an online advertisement, the method comprising:
informing a plurality of advertisers of the opportunity to realize the online advertisement;
providing demographic information to each advertiser of the plurality of advertisers, wherein the demographic information is associated with a user that is associated with the opportunity to realize the online advertisement;
determining an individual reserve price for each advertiser of the plurality of advertisers based on one or more individual bidding preferences associated with the advertiser and the demographic information associated with the user; and
conducting an auction associated with the opportunity to realize the online advertisement among the plurality of advertisers based on the demographic information of the user and one or more of the determined individual reserve prices.

2. The computer-implemented method of claim 1, wherein conducting the auction comprises:
identifying one or more candidate bidders from the plurality of advertisers, wherein each candidate bidder is associated with a bidding price that is greater than the individual reserve price associated with the candidate bidder;
identifying a winning bidder that is associated with a highest bidding price of the bidding prices associated with the one or more candidate bidders;
determining a winning price for the winning bidder, wherein:
the winning price is a second highest price among the bidding prices associated with the one or more candidate bidders when the second highest price is greater than or equal to the individual reserve price associated with the winning bidder; and
the winning price is the individual reserve price associated with the winning bidder when the second highest price is less than the individual reserve price associated with the winning bidder.

3. The computer-implemented method of claim 1, wherein the demographic information associated with the user includes user information stored in cookies of an interact surfing device associated with the user.

4. The computer-implemented method of claim 3, wherein the demographic information associated with the user that is provided to each advertiser of the plurality of advertisers is selected based on historical bidding preference of the advertiser.

5. The computer-implemented method of claim 1, wherein informing the plurality of advertisers of the opportunity to realize the online advertisement further comprises:
providing to each advertiser of the plurality of advertisers at least one of information related to a section of a webpage where the online advertisement is about to be rendered, a Uniform Resource Locater of a webpage where the online advertisement is about to be rendered, and a size of the section of the webpage for rendering the online advertisement.

6. The computer-implemented method of claim 1, wherein realization of the online advertisement comprises at least one of an impression of the online advertisement, a click-through associated with the online advertisement, an acquisition associated with the online advertisement, and a conversion associated with the online advertisement.

7. The computer-implemented method of claim 1, wherein the individual reserve price for each advertiser of the plurality of advertisers is calculated using the equation:
vᵢ=E_{u˜\tilde{F}}_{_{U}}[p_{i,u}sᵢ],
wherein:
the subscription i represents the i^{th} advertiser;
the subscription u represents a type of the user defined by the demographic information associated with the user that is provided to the i^{th} advertiser;
vᵢ represents the reserve price associated with the i^{th} advertiser;
E_{u˜\tilde{F}}_{_{U}} represents an value expectation;
p_{i,u} represents a probability that a user of type u clicks on an advertisement of the i^{th} advertiser; and
sᵢ represents a value of realizing the online advertisement for the i^{th} advertiser.

8. A server comprising:
a computer-readable storage medium comprising a set of instructions for conducting second price auction associated with an opportunity to realize an online advertisement;
a processor in communication with the computer-readable storage medium that is configured to execute the set of instructions stored in the computer-readable storage medium and is configured to:
inform a plurality of advertisers of the opportunity to realize the online advertisement;
provide demographic information to each advertiser of the plurality of advertisers, wherein the demographic information is associated with a user that is associated with the opportunity to realize the online advertisement;
determine an individual reserve price for each advertiser of the plurality of advertisers based on one or more individual bidding preferences associated with the advertiser and the demographic information associated with the user; and
conduct an auction associated with the opportunity to realize the online advertisement among the plurality of advertisers based on the demographic information of the user and one or more of the determined individual reserve prices.

9. The server of claim 8, wherein the auction comprises:
identifying one or more candidate bidders from the plurality of advertisers, wherein each candidate bidder is associated with a bidding price that is greater than the individual reserve price associated with the candidate bidder;
identifying a winning bidder that is associated with a highest bidding price of the bidding prices associated with the one or more candidate bidders;
determining a winning price for the winning bidder, wherein:
the winning price is a second highest price among the bidding prices associated with the one or more candidate bidders when the second highest price is greater than or equal to the individual reserve price associated with the winning bidder; and
the winning price is the individual reserve price associated with the winning bidder when the second highest price is less than the individual reserve price associated with the winning bidder.

10. The server of claim 8, wherein the individual reserve price for each advertiser of the plurality of advertisers is calculated using the equation:
vᵢ=E_{u˜\tilde{F}}_{_{U}}[p_{i,u}sᵢ],
wherein:
the subscription i represents the i^{th} advertiser;
the subscription u represents a type of the user defined by the demographic information associated with the user that is provided to the i^{th} advertiser;
vᵢ represents the reserve price associated with the i^{th} advertiser;
E_{u˜\tilde{F}}_{_{U}} represents an value expectation;
p_{i,u} represents a probability that a user of type u clicks on an advertisement of the i^{th} advertiser; and
sᵢ represents a value of realizing the online advertisement for the i^{th} advertiser.

11. The server of claim 10, wherein the demographic information associated with the user that is provided to each advertiser of the plurality of advertisers is selected based on historical bidding preference of the advertiser.

12. The server of claim 8, wherein informing the plurality of advertisers of the opportunity to realize the online advertisement further comprises:
providing to each advertiser of the plurality of advertisers at least one of information related to a section of a webpage where the online advertisement is about to be rendered, a Uniform Resource Locater of a webpage where the online advertisement is about to be rendered, and a size of the section of the webpage for rendering the online advertisement.

13. The server of claim 8, wherein realization of the online advertisement comprises at least one of an impression of the online advertisement, a click-through associated with the online advertisement, an acquisition associated with the online advertisement, and a conversion associated with the online advertisement.

14. A compute-readable storage medium comprising a set of instructions for conducting a second price auction associated with an opportunity to realize an online advertisement, the set of instructions to direct a processor to perform acts of:
informing a plurality of advertisers of the opportunity to realize the online advertisement;
providing demographic information to each advertiser of the plurality of advertisers, wherein the demographic information is associated with a user that is associated with the opportunity to realize the online advertisement;
determining an individual reserve price for each advertiser of the plurality of advertisers based on one or more individual bidding preferences associated with the advertiser and the demographic information associated with the user; and
conducting an auction associated with the opportunity to realize the online advertisement among the plurality of advertisers based on the demographic information of the user and one or more of the determined individual reserve prices.

15. The computer-readable storage medium of claim 14, wherein the auction comprises:
identifying one or more candidate bidders from the plurality of advertisers, wherein each candidate bidder is associated with a bidding price that is greater than the individual reserve price associated with the candidate bidder;
identifying a winning bidder that is associated with a highest bidding price of the bidding prices associated with the one or more candidate bidders;
determining a winning price for the winning bidder, wherein:
the winning price is a second highest price among the bidding prices associated with the one or more candidate bidders when the second highest price is greater than or equal to the individual reserve price associated with the winning bidder; and
the winning price is the individual reserve price associated with the winning bidder when the second highest price is less than the individual reserve price associated with the winning bidder.

16. The computer-readable storage medium of claim 14, wherein the demographic information associated with the user includes user information stored in cookies of an internet surfing device associated with the user.

17. The computer-readable storage medium of claim 16, wherein the demographic information associated with the user that is provided to each advertiser of the plurality of advertisers is selected based on historical bidding preference of the advertiser.

18. The computer-readable storage medium of claim 14, wherein informing the plurality of advertisers of the opportunity to realize the online advertisement further comprises:
providing to each advertiser of the plurality of advertisers at least one of information related to a section of a webpage where the online advertisement is about to be rendered, a Uniform Resource Locater of a webpage where the online advertisement is about to be rendered, and a size of the section of the webpage for rendering the online advertisement.

19. The computer-readable storage medium of claim 14, wherein realization of the online advertisement comprises at least one of an impression of the online advertisement, a click-through associated with the online advertisement, an acquisition associated with the online advertisement, and a conversion associated with the online advertisement.

20. The computer-readable storage medium of claim 14, wherein the individual reserve price for each advertiser of the plurality of advertisers is calculated using the equation:
vᵢ=E_{u˜\tilde{F}}_{_{U}}[p_{i,u}sᵢ],
wherein:
the subscription i represents the i^{th} advertiser;
the subscription u represents a type of the user defined by the demographic information associated with the user that is provided to the i^{th} advertiser;
vᵢ represents the reserve price associated with the i^{th} advertiser;
E_{u˜\tilde{F}}_{_{U}} represents an value expectation;
p_{i,u} represents a probability that a user of type u clicks on an advertisement of the i^{th} advertiser; and
sᵢ represents a value of realizing the online advertisement for the i^{th} advertiser.
